(19) United States
(12) Patent Application Publication
(10) Pub. No.: US 2021/0295130 A1
(43) Pub. Date: Sep. 23, 2021

(54) ARTIFICIAL INTELLIGENT AGENT REWARDING METHOD DETERMINED BY SOCIAL INTERACTION WITH INTELLIGENT OBSERVERS

(71) Applicant: Mohammad Rasoolinejad, Evanston, IL (US)

(72) Inventor: Mohammad Rasoolinejad, Evanston, IL (US)

(21) Appl. No.: 17/201,781

(22) Filed: Mar. 15, 2021

Related U.S. Application Data
(60) Provisional application No. 62/992,054, filed on Mar. 19, 2020.

(51) Int. Cl. G06N 3/00; G06N 20/00; G06N 3/04; G06K 9/00

(52) U.S. Cl. CPC G06N 3/008; G06N 3/006; G06K 9/00335; G06N 3/0454; G06K 9/00315; G06N 20/00

(57) ABSTRACT

A method of training an artificial intelligence agent's behavior to achieve the highest social approval by assigning rewards to its actions. This set of rewards is used in reinforced learning or any other learning system to modify the learning agent's behavior. The agent will do a set of trial actions that induces a set of social reactions from the intelligent observers. Each reaction will be analyzed by specialized networks to assign a social approval value as a reward to train the machine learning algorithm. The machine learning agent modifies its actions to achieve the highest anticipated social rewards in the future. The agent has a reinforcement learning unit that is trained by the reward value determined by already trained networks in the reward unit. Each set of actions produces reactions that are captured by sensors such as, but not limited to, vision and audio sensors. These reactions—such as facial expression, voice tone, and body language—will be classified as positive or negative and a reward value will be assigned to them. This set of reward values would then be used to train and modify the agent's behavior.

### CROSS-REFERENCE TO RELATED APPLICATION

This application claims the benefit of priority of U.S. provisional application No. 62/992,054, filed Mar. 19, 2020, the contents of which are herein incorporated by reference.

### BACKGROUND OF THE INVENTION

The present invention relates to a rewarding system to train a learning agent and its neural networks, and more particularly to assign the reward value by the agent's social interactions.

Neural networks are special machine learning models that use a set of inputs to predict an output. These neural networks are optimized to give the best output from the received input.

Reinforcement learning is a method of training learning agents in which an agent takes actions in an operating environment. The actions result in reactions by intelligent observers and reactions interpreted into a reward and a representation of the state, which are fed back into the agent. Agent takes future actions in the environment to maximize the notion of cumulative reward.

Typically, the reward value is set by a supervisor which approves or disapproves of the actions. This rewarding scheme is time-consuming and is only applicable to a limited number of actions. Because general artificial intelligent agents perform a huge number of actions, setting reward value manually for each action is not feasible. A new rewarding scheme is required to set the reward automatically without human supervision.

As can be seen, there is a need for improved rewarding scheme in learning agents to set the reward value in real-time which is faster and more efficient than manual rewarding.

### SUMMARY OF THE INVENTION

In one aspect of the present invention, a social reward method for an artificial intelligent agent is provided, comprising (a) perform an action in the operating environment and receive change in the state of the operating environment, (b) detect the reaction of the intelligent observers present in the operating environment, (c) classify the reaction of the intelligent observers to positive and negative, (d) assign a reward value to the corresponding action based on intelligent observers reaction, and (e) use the reward and corresponding action to further train the learning agent.

In some embodiments, facial, and verbal clues are used in order to classify the reaction of the intelligent observers. Also, body posture and body movement clues are used in order to classify the reaction of intelligent observers.

In some embodiments, a trial training method configured to start with random action trials and receive the reaction of intelligent observant, assign the social reward value to the reaction.

In another aspect of the present invention, an artificial intelligent agent with social reward is provided, comprising a sensor unit configured to receive one or more observed events in an operating environment, a memory unit configured to receive one or more observed events and store them in physical memory space, a social reward unit configured to analyze the one or more observed event and assign them social reward value based on the reaction of intelligent observers, a reinforced learning unit configured to use the action and its reward value to modify the plurality of operational parameters over time in the learning deep neural network to maximize estimated future cumulative rewards, and an actuator unit configured to use the output of the learning unit and do appropriate actions to achieve maximize estimated future cumulative rewards.

In some embodiments, machine learning algorithms which receive intelligent observer reaction associated with certain agent's action and assign a reward value base of approval or disapproval of the observer. Neural networks are trained to detect the social clues from the observed reaction of intelligent observant and assign social reward values based on positive and negative reaction. These neural networks are configured to analyze the video, audio, language and body movement of intelligent observant.

In some embodiments, several neural networks are configured to analyze the instances of an observed event. These networks can include, visual network, audio network, speech network, etc.

In some embodiments, the visual network is configured to detect and classify the key features of a visual data stream. Face detection, facial expression, body language and emotion classifier are configured in the visual network.

In some embodiments, the audio network is configured to detect and classify the key features of an audio data stream. Voice tone and emotion classifiers are configured in the audio network.

In some embodiments, the speech network is configured to detect and classify the key features of a spoken language. Features like word frequency, word embeddings and language sentiment are configured in the speech network.

In some embodiments, a collector network is configured to receive the output embeddings from instance networks and to assign a total social reward score to the action. The reward value is determined based on the feedback from the intelligent observer.

In some embodiments, a learning unit neural network is configured to use the reward value determined by the reward unit to modify the plurality of operational parameters over time based on an analysis of one or more observed events. The parameters of the network are modified to maximize estimated future cumulative rewards. The subsequent actions are selected in the agent's network generating the highest estimated future cumulative social rewards. Using the prediction error of the experience and reward tuple to update the current values of the parameters of the agent's learning network is comprised of updating the current values of the parameters of the network to reduce the error and to maximize estimated future cumulative social rewards. The values of the parameters of the agent's learning network are periodically synchronized and updated based on future observations that characterize the next state of the environment.

In some embodiments, A trial training method configured to start with random action trials and perturbations from the current state of the learning network, receive the reaction of intelligent observant, assign the social reward value to the reaction, and further train the learning network based on the reward value.

These and other features, aspects and advantages of the present invention will become better understood with reference to the following drawings, description and claims.

### BRIEF DESCRIPTION OF THE DRAWINGS

FIG. 1 is a flow chart of the artificial intelligent agent.

FIG. 2 is a flow chart of a social reward unit.

FIG. 3 is a flow chart of a social rewarding method.

FIG. 4 is a schematic of the social rewarding method.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide an artificial intelligent agent rewarding system that is managed by one or more neural networks. A system may include one or more artificial intelligence agents as described herein.

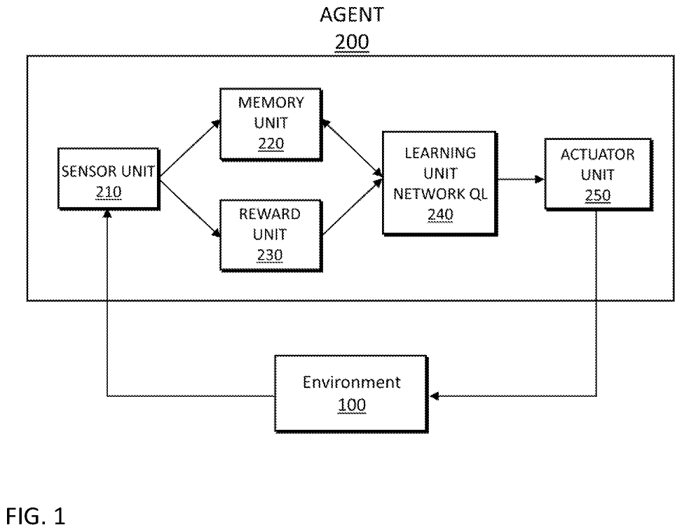

An artificial intelligent agent memory structure is shown in reference to FIG. 1. The artificial intelligent agent 200 includes a sensor unit 210, a memory unit 220, a social reward unit 230, a learning unit network QL 240, and an actuator unit 250. The artificial intelligent agent 200 interacts with an environment 100 via the sensor unit 210 and the actuator unit 250.

The social reward unit 230 includes a set of analyzers that assign a reward value to the actions of the intelligent agent 200. The reward values can be used to train the intelligent agent through reinforcement learning. Reinforcement learning is a special method to train artificial intelligence and is known to the ones familiar with the subject matter. In this method, the actions of the agent are tagged with positive and negative reward values. The artificial intelligent agent will try to maximize the cumulative reward value by doing more desirable actions. Each action or event is associated with a reward value which will be stored together as a tuple. The reward value will be used in the training period and may or may not be deleted afterward.

The actuator unit 250 contains all actuators that artificial intelligent agent uses to interact with environment 100. These actuators can include mechanical arms, speakers, monitors, and the like.

Each artificial intelligent agent 200 is capable of receiving a huge amount of data and interactions at every moment. Analyzing this large amount of data requires sophisticated algorithms and procedures. In aspects of the present invention, a method is disclosed to efficiently assign reward values to the artificial intelligent agent 200 actions.

The artificial intelligent agent 200 includes several deep neural networks arranged in various units. Neural networks are special machine learning models that use a set of inputs to predict an output. These networks are optimized to give the best output from the received input. The optimal parameters of such networks, and any other necessary information needed for the agent to work properly, are stored in the memory unit 220. These parameters can be constant or may change over time, as in the case of a reinforced learning agent whose parameters of the learning unit network QL 240 are updated as more data and responses are gathered from environment 100.

The artificial intelligent agent 200 receives a vast amount of data from its environment 100 through the sensor unit 210. The sensor unit 210 observes the artificial intelligent agent's environment 100 and sends the event data to the memory unit 220. The event observations might or might not be used to train the agent network QL 240.

A set of analyzers analyze the behavior of other agents behavior who observe the action of artificial intelligent agent 200. They can consist of humans, trained artificial agents or a simulated environment, which here is called the “intelligent observer”.

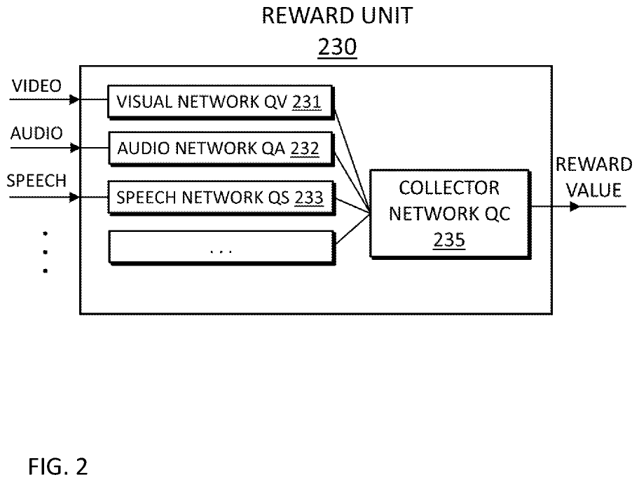

As seen in FIG. 2, the event social reward unit 230 contains a plurality of neural network classifiers to tag the observed reactions. The input from the sensor unit 210 can be in many formats such as video, audio, smell, touch, temperature, etc. Different instances regarding the same event may be analyzed by specialized networks. These networks can include, visual network QV 231, audio network QA 232, speech network QS 233, etc.

After feature extraction from instances of each observation, a collector network QC 235 is configured to receive the output embeddings from instance networks and to assign a total social reward score to the reaction.

Each specific observation consists of one or more instances, such as video, audio, smell, touch, temperature, etc. These instances are analyzed by type-specific networks.

The agent starts with a set of trial actions that induces a set of social reactions from the intelligent observer. Each set of actions produces reactions that are captured by sensors. Each reaction will be analyzed by social reward unit 230 to assign a social reward value. These networks are already trained to identify and classify the reaction of the intelligent observer.

If an action generates a positive reaction, a high reward value will be assigned to the action. Similarly, the negative reaction produces a low reward value. Encouragement by the intelligent environment produces high reward value, and discouragement produces low reward value. The reward value is a function of the intensity of the reaction and the number of observations.

The social reward unit 230 includes special networks to analyze the instance of each input in the format of the video, audio, etc. The input to these networks can be any feature that helps to classify the reaction of intelligent agents such as facial expression and body movements analyzed by visual network 231, voice tone analyzed by audio network 232, verbal encouragement and discouragements analyzed through speech recognition and natural language processing network QS 233.

The visual input goes to the visual network QV 231. Facial recognition and body language classifiers are built into this network to classify the intelligent environment's emotions and respond as positive or negative.

The audio input goes to audio network QA 232 in which the sound will be analyzed based on tone, pitch and frequency.

Speech recognition and natural language processing unit 233 is also used to capture the verbal encouragement and discouragement of an intelligent observer from the content of speech and its wording.

A similar analysis will be performed on other inputs from the sensor unit to classify the reaction. The result from all of these networks then goes to collector network QC 235, to sum up all the reactions and assign a total reward score to the action.

The tuple of action and its reward score will then be saved in the agent's data storage or memory system 220 as an experience tuple. These sets of tuples will be used to modify the behavior of the agent itself by reinforced learning or any other learning scheme.

The parameters of network QL 240 are modified to maximize estimated future cumulative rewards. The actions approved by the intelligent observer will, therefore, be repeated while the disapproved ones will be avoided.

In the training stage, the optimized parameters of the network QL 240 are perturbed from their current state to generate imperfect actions. These perturbations allow the actions to deviate from the network's current state to further improve the agent's behavior.

The reward from these perturbed actions can be positive or negative based on the intelligent environment's reaction. This training reinforces the desired perturbations and diminishes the undesirable ones. The magnitude of perturbation diminishes and goes to zero as the agent finishes the training phase and the agent's learning network QL 240 parameters reach the steady-state.

In some embodiments, the learning network QL starts with no initial parameters. The agent begins with random trial actions and uses the social reward obtained to train the initial parameters of the learning network QL.

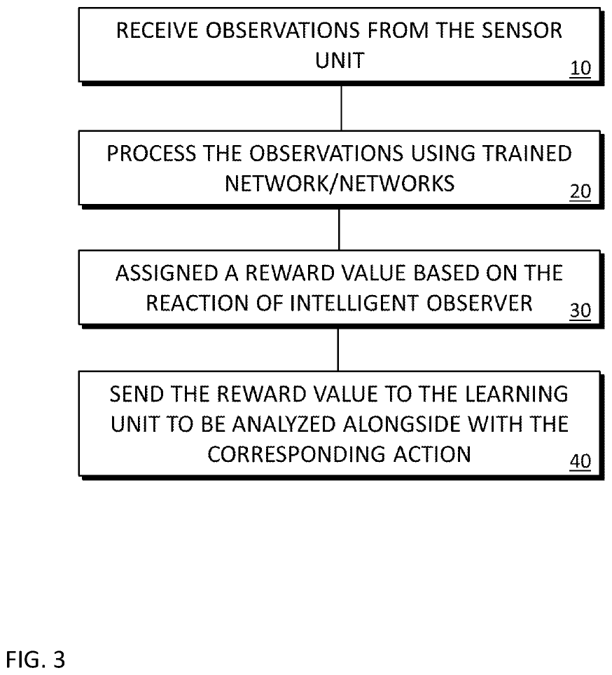

The rewarding method based on social interactions is shown in reference to FIG. 3. The method is based on classification by deep neural networks that receive observation events at 10 received from the sensor unit. The method processes the observed reactions at 20 and utilizes a set of deep neural networks that analyze an observed event. At block 30, each observed reaction is assigned a reward value based on the reaction of intelligent observers. At block 40, the tuple of action and its social reward is sent to the learning unit as an experience tuple to train the learning network QL.

The method is comprised of updating the parameters of the learning network QL based on future observations and rewards.

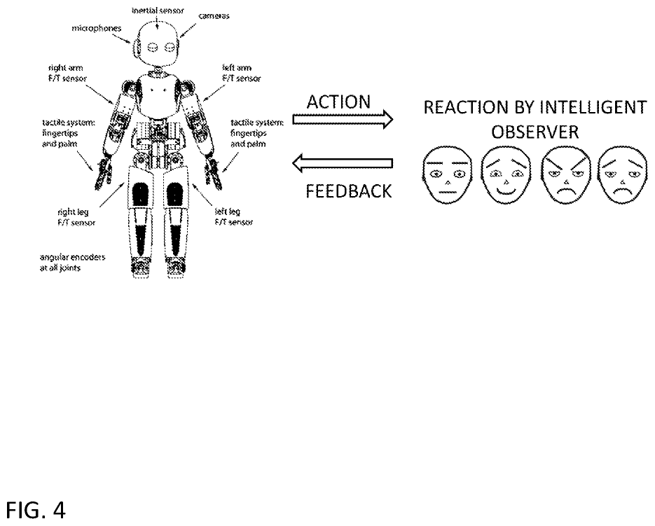

The schematic rewarding procedure based on social interactions is shown in reference to FIG. 4. The figure is not to be taken in a limiting sense but is made merely for the purpose of illustration. The artificial intelligent agent performs certain actions that result in the reaction of the intelligent observer. The intelligent observer's face, body movement, voice tone, language, temperature, etc. are indicative of his emotional status. The agent's sensors record the reaction as feedback and send it to the social reward unit to determine the reward value.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. The social reward method for artificial intelligent agent, comprising:
(a) perform an action in the operating environment and receive change in the state of the operating environment;
(b) detect the reaction of the intelligent observers present in the operating environment;
(c) classify the reaction of the intelligent observers to positive and negative;
(d) assign a reward value to the corresponding action based on intelligent observers reaction;
(e) use the reward and corresponding action to further train the learning agent.

2. The social reward method of claim 1, further comprising:
Using facial, and verbal clues in order to classify the reaction of the intelligent observers.

3. The social reward method of claim 1, further comprising:
Using body posture and body movement clues in order to classify the reaction of the intelligent observers.

4. The social reward method of claim 1, further comprising:
A trial training method configured to start with random action trials and receive the reaction of intelligent observant, assign the social reward value to the reaction.

5. An artificial intelligent agent with social reward, comprising:
a sensor unit configured to receive one or more observed events in an operating environment;
a memory unit configured to receive one or more observed events and store them in physical memory space;
a social reward unit configured to analyze the one or more observed event and assign them social reward value based on the reaction of intelligent observers;
a reinforced learning unit configured to use the action and its reward value to modify the plurality of operational parameters over time in the learning deep neural network to maximize estimated future cumulative rewards; and
an actuator unit configured to use the output of the learning unit and do appropriate actions to achieve maximize estimated future cumulative rewards.

6. The social reward unit of claim 5, further comprising:
Machine learning algorithms which receive intelligent observer reaction associated with certain agent's action and assign a reward value base of approval or disapproval of the observer.

7. The machine learning algorithms of claim 6, further comprising:
Neural networks trained to detect the social clues from the observed reaction of intelligent observant and assign social reward values based on positive and negative reaction. These neural networks are configured to analyze the video, audio, language and body movement of intelligent observant.

8. The neural networks of claim 7, further comprising:
One or multiple video neural networks that are trained to detect social clues such as face recognition, body movement and image/video embeddings to classify them based on positive or negative reaction.

9. The neural networks of claim 7, further comprising:
One or multiple audio neural networks that are trained to detect social clues such as voice tone, voice amplitude, voice frequency and audio embeddings to classify them based on positive or negative reaction.

10. The neural networks of claim 7, further comprising:
One or multiple speech recognition neural networks that are trained to detect social clues such as negative/positive words, sentiment, and language embeddings to classify them based on positive or negative reaction.

11. The neural networks of claim 7, further comprising:
A collector network that receives all embedding from specialized networks and determined the reward value.

12. The artificial intelligent agent of claim 5, further comprising:
A trial training method configured to start with random action trials and perturbations from the current state of the learning network, receive the reaction of intelligent observant, assign the social reward value to the reaction, and further train the learning network based on the reward value.

13. The learning unit of claim 5, further comprising:
Using the prediction error of the experience and reward tuple to update the current values of the parameters of the agent's learning network is comprised of updating the current values of the parameters of the network to reduce the error and to maximize estimated future cumulative social rewards.

14. The learning unit of claim 5, wherein the values of the parameters of the agent's learning network are periodically synchronized and updated based on future observations that characterize the next state of the environment.
